(19) United States
(12) Patent Application Publication
(10) Pub. No.: US 2025/0236960 A1
(43) Pub. Date: Jul. 24, 2025

(54) GREEN HYDROGEN PRODUCTION THROUGH ELECTROLYSIS OF HIGH-PRESSURE AND HIGH-TEMPERATURE UPSTREAM BOILER BLOWDOWN WASTE WATER STREAM

(71) Applicant: SAUDI ARABIAN OIL COMPANY, Dhahran (SA)

(72) Inventor: Khalid Yahya Hazazi, Thuwal (SA)

(73) Assignee: SAUDI ARABIAN OIL COMPANY, Dhahran (SA)

(21) Appl. No.: 18/418,488

(22) Filed: Jan. 22, 2024

(51) Int. Cl. C25B 1/04; C25B 9/67; C25B 15/08

(52) U.S. Cl. CPC C25B 1/04; C25B 9/67; C25B 15/081

(57) ABSTRACT

Described is a system and method for green hydrogen production via electrolysis. The system includes a steam boiler unit configured to produce a discharged waste water stream, an electrolysis unit configured to produce hydrogen and oxygen from the discharged waste water stream; and a hydrogen storage unit for storing a portion of the hydrogen produced by the electrolysis unit as a product.

### BACKGROUND

Electrolysis is a process used to produce green hydrogen from water using electricity, typically from renewable sources, such as solar power. The process involves using an electrolyzer, which splits water molecules into hydrogen and oxygen gases through an electrochemical reaction.

Water purification may be necessary prior to electrolysis when the water being used for electrolysis contains a significant amount of ions from salts. During a water purification step, seawater is desalinated using reverse-osmosis technology. The purified water is then fed into an electrolyzer, or electrolysis unit, which consists of an anode and a cathode separated by a membrane. As the electric current is passed through the water, the anode attracts negatively charged hydroxide ions, while the cathode attracts positively charged hydrogen ions. Water molecules lose electrons and form oxygen gas and hydroxide ions at the anode side. The hydrogen ions gain electrons and form hydrogen gas at the cathode side. After the hydrogen gas is formed, it may be collected and stored at high pressure for use in fuel cells or other applications.

Typically, hydrogen production via electrolysis is conducted at ambient conditions, including room temperature and atmospheric pressure. Maintaining ambient conditions during electrolysis requires a significant energy input for the water splitting reaction and the hydrogen gas compression. As shown in FIG. 1, a conventional electrolysis process 100 requires desalinated water produced using a water desalination process 102. The water desalination process 102 increases the overall cost of green hydrogen production and storage 104. Thus, while electrolysis for green hydrogen production has a low carbon footprint compared to fossil fuels hydrogen-based production methods, it is still relatively expensive.

Accordingly, there exists a need for reducing the overall energy requirement of conventional electrolysis to enable cost-effective green hydrogen production.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for producing hydrogen. The system comprises a steam boiler unit configured to produce a discharged waste water stream; an electrolysis unit configured to produce hydrogen and oxygen from the discharged waste water stream; and a hydrogen storage unit for storing at least a portion of the hydrogen produced by the electrolysis unit as a product.

In another aspect, the discharged waste water stream is produced via a boiler blowdown procedure.

In another aspect, a flow line feeds at least a portion of the hydrogen produced by the electrolysis unit to a refinery.

In another aspect, the system comprises one or more heat exchangers configured to receive the discharged waste water stream and at least one flow line connecting the steam boiler unit with the one or more heat exchangers to reduce a temperature of the discharged waste water stream.

In another aspect, the temperature of the discharged waste water stream is reduced to between approximately 50° C. and approximately 120° C.

In another aspect, a temperature of the discharged waste water stream is between approximately 50° C. and approximately 400° C.

In another aspect, the electrolysis unit is a proton exchange membrane (PEM) electrolyzer, an alkaline electrolyzer, or a solid oxide electrolyzer.

In another aspect, a pH of the discharged waste water stream is between 2 and 11.

In another aspect, a total dissolved solids (TDS) concentration of the discharged waste water stream is between approximately 100 milligrams (mg) per liter (L) and approximately 500 mg/L.

In another aspect, a flow line releases the oxygen produced from the discharged waste water stream.

In yet another aspect, embodiments disclosed herein relate to a method for producing hydrogen. The method comprises producing, by a steam boiler unit, a discharged waste water stream; feeding the discharged waste water stream to an electrolysis unit; producing hydrogen and oxygen from the discharged waste water stream using the electrolysis unit; and storing at least a portion of the hydrogen produced by the electrolysis unit in a hydrogen storage unit as a product.

In another aspect, the method comprises outputting at least a portion of the hydrogen produced by the electrolysis unit to a refinery.

In another aspect, the method comprises feeding the discharged waste water stream from the steam boiler unit to one or more heat exchangers configured to reduce the temperature of the discharged waste water stream; and feeding the discharged waste water stream having a reduced temperature to the electrolysis unit.

In another aspect, the hydrogen fed to the refinery is used for at least one of hydrodesulphurization, hydroisomerization, dearomatization, and hydrocracking.

In another aspect, the oxygen produced from the discharged waste water stream is captured for use in industrial processes.

Other aspects and advantages of the claimed subject matter will be apparent from the following description and the appended claims.

### BRIEF DESCRIPTION OF DRAWINGS

FIG. 1 illustrates a conventional green hydrogen production process according to prior art.

FIG. 2 illustrates a boiler blowdown process according to prior art.

FIG. 3 illustrates an electrolysis process using boiler blowdown according to one or more embodiments of the present disclosure.

FIG. 4 illustrates green hydrogen production and storage according to one or more embodiments of the present disclosure.

FIG. 5 illustrates thermodynamics for water electrolysis at atmospheric pressure according to prior art.

FIG. 6 illustrates a Pourbaix diagram of water under ambient conditions according to prior art.

FIG. 7 illustrates a system for green hydrogen production according to one or more embodiments of the present disclosure.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

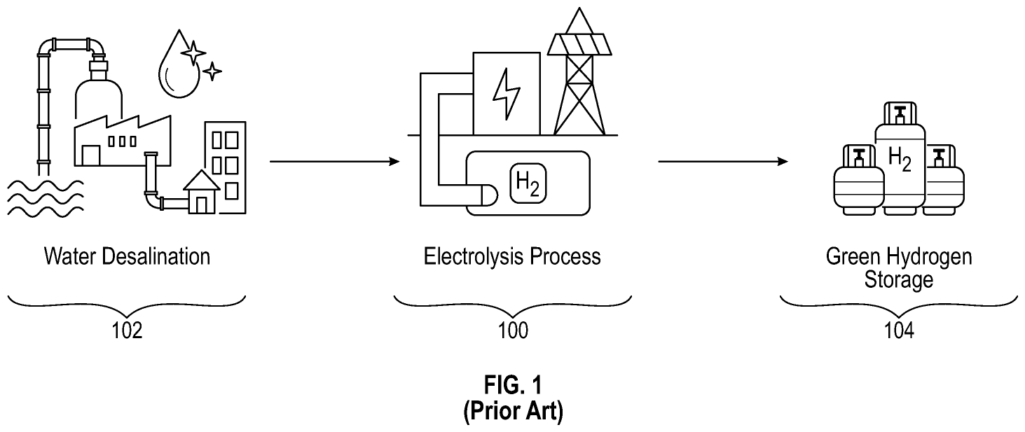

In the following description of FIGS. 1-7, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a passive soil gas sample system” includes reference to one or more of such systems.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Embodiments of the present disclosure relate to the field of green hydrogen production. Embodiments of the present disclosure relate to systems and methods of using waste water for hydrogen production via an electrolysis process. Embodiments of the present disclosure relate to systems and methods for cost-effective green hydrogen production, which involves the utilization of high-pressure, high-temperature, and low-salinity upstream waste water streams, such as boiler blowdown.

Steam boiler units are closed vessels designed to generate steam, or gaseous water, for heating purposes or power generation in a wide range of industrial applications. In the oil and gas industry, steam boilers are primarily used for oil refineries, natural gas processing, and power generation. Steam boilers need to be replenished with boiler feedwater to continuously produce steam. Operating a steam boiler causes small amounts of solids from materials contacted by the steam to dissolve. The dissolved impurities may concentrate with continued use of the steam boiler and cause damage to the steam boiler. The impurities in steam boilers may be referred to as total dissolved solids, or TDS. To prevent the build-up of impurities within a steam boiler, a boiler blowdown procedure may be performed where a portion of the water from the steam boiler is intentionally discharged to maintain the TDS concentration within an acceptable range.

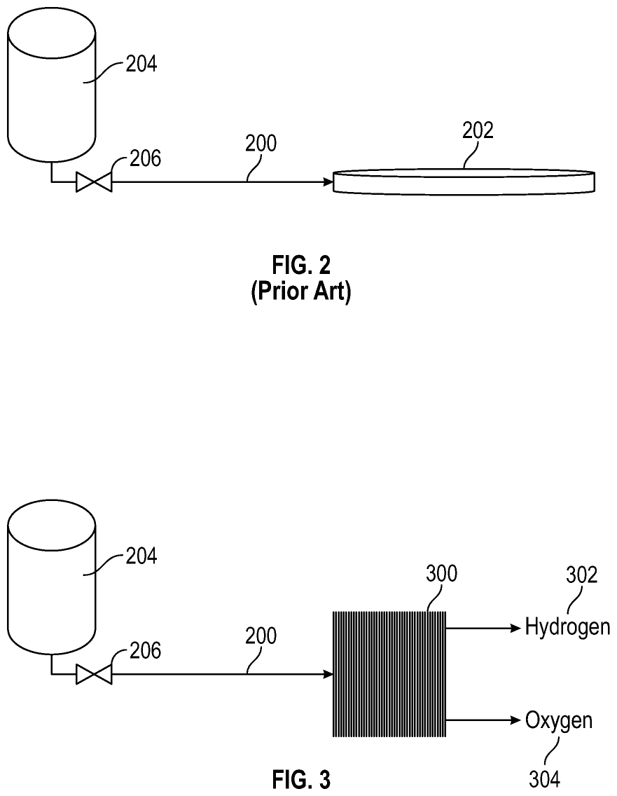

As shown in FIG. 2, a typical boiler blowdown procedure results in a discharged waste water stream 200 that is typically disposed in an evaporation pond 202. A boiler blowdown procedure may involve partially draining a steam boiler unit 204, under pressure, to remove sediments and other solids and maintain TDS levels below a predetermined concentration to maximize performance of the steam boiler unit 204. The steam boiler unit 204 may be equipped with or connected with one or more valves 206. The one or more valves 206 may be slow-opening valves and/or quick-opening valves. Additionally, multiple valves 206 may be arranged in series. During a blowdown procedure, the one or more valves 206 are opened to drain the waste water from the steam boiler unit 204.

According to one or more embodiments of this disclosure, the discharged waste water stream 200, which is at a high pressure, a high temperature, and a low salinity following the boiler blowdown procedure, may be used directly to produce green hydrogen using an efficient electrolysis process. In one or more embodiments, the discharged waste water stream 200 may be discharged and collected from the steam boiler unit 204 at a temperature ranging from 50° C., 100° C., 150° C., 200° C., 250° C., 300° C., or 350° C. to 100° C., 150° C., 200° C., 250° C., 300° C., 350° C., or 400° C., where any lower limit may be combined with any mathematically feasible upper limit.

In one or more embodiments, the discharged waste water stream 200 may be discharged and collected from the steam boiler unit 204 at a pressure ranging from 10, 15, 20, 25, 30, 35, 40, or 45 bar to 15, 20, 25, 30, 35, 40, 45, or 50 bar, where any lower limit may be combined with any mathematically feasible upper limit. In one or more embodiments, the temperature of the discharged waste water stream 200 may be reduced. For instance, the steam boiler unit 204 may be in fluid communication with one or more simple heat exchangers configured to receive the discharged waste water stream 200 and reduce the temperature of the discharged waste water stream for certain applications.

In contrast with conventional electrolysis, there is no need for an ion separation step using the systems and methods described herein, providing an additional reduction in the total energy requirement. Additionally, the discharged waste water stream 200 has a relatively low TDS, and the ions present in the discharged waste water stream 200 may be directly utilized in the electrolysis process. For instance, the TDS concentration of the discharged waste water stream 200 may range from approximately 100, 150, 200, 250, 300, 350, 400, or 450 milligrams (mg) per liter (L) to approximately 150, 200, 250, 300, 350, 400, 450, and 500 mg/L, where any lower limit may be combined with any mathematically feasible upper limit.

In the systems and methods described herein, the discharged waste water stream 200 produced after performing a boiler blowdown procedure on the steam boiler unit 204 may be fed to an electrolysis unit 300, or electrolyzer, to produce hydrogen 302 and oxygen 304, as depicted in FIG. 3. The electrolysis unit 300 may be a proton exchange membrane (PEM) electrolyzer, an alkaline electrolyzer, a solid oxide electrolyzer, or any type of electrolysis unit configured to use electricity to split water into hydrogen and oxygen. Each electrolyzer differs in the type of electrolyte material used and the ionic species conducted. For instance, a PEM electrolyzer uses a plastic material as the electrolyte material. The electrolyte of an alkaline electrolyzer is either a liquid alkaline solution, such as sodium or potassium hydroxide, or a solid alkaline exchange membrane (AEM). Solid oxide electrolyzers operate at higher temperatures than PEM and alkaline electrolyzers. For instance, solid oxide electrolyzers may operate at approximately 700° C. to 800° C., PEM electrolyzers may operate at approximately 70° C. to 90° C., and commercial alkaline electrolyzers may operate at less than 100° C.

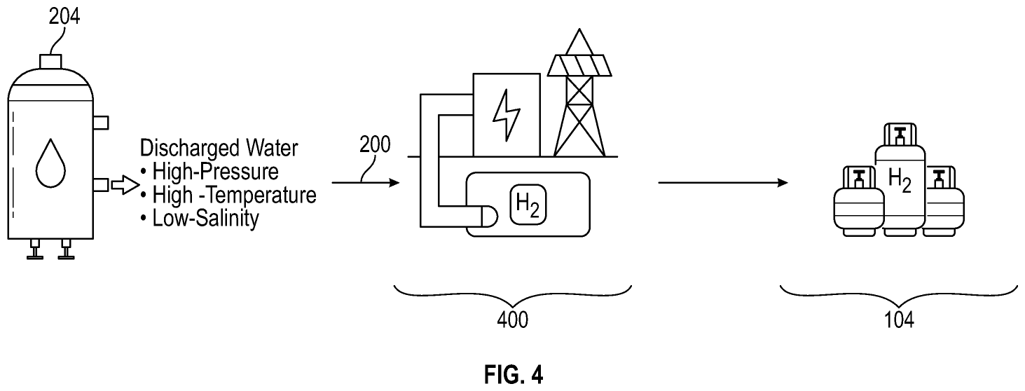

FIG. 4 illustrates a method for green hydrogen production using a low-energy electrolysis process 400 according to embodiments of this disclosure. As described above, the discharged waste water stream 200 produced via boiler blowdown is high in temperature and pressure and low in salinity. Therefore, the energy requirement for electrolysis and, ultimately, hydrogen production is reduced. For instance, the energy that is typically required for the water splitting reaction in electrolysis may be supplied as heat from the discharged waste water stream 200 due to its elevated temperature.

FIG. 5 illustrates thermodynamics for water electrolysis at atmospheric pressure according to prior art. As shown, the total energy demand of electrolysis increases slightly with increasing temperature. Electrical energy demand decreases with increasing temperature, and heat demand increases with increasing temperature. The efficiency of water splitting is typically higher at higher temperatures, such as greater than 100° C., which is provided by the systems and methods described herein. Moreover, the high pressure of the discharged waste water stream produced by the steam boiler unit reduces the overall energy required to pressurize the produced green hydrogen gas for storage. Further, water desalination may be avoided since the discharged waste water stream is relatively low in salinity with a TDS in the range of 100 parts-per-million (ppm) to 500 ppm, or 100-500 mg/L. A TDS concentration of water in the range of approximately 100 mg/L to approximately 500 mg/L does not impact the electrolysis process. In one or more embodiments, the TDS of the discharged waste water stream ranges from 100, 150, 200, 250, 300, 350, 400, and 450 ppm to 150, 200, 250, 300, 350, 400, 450, and 500 ppm, where any lower limit may be combined with any mathematically feasible upper limit.

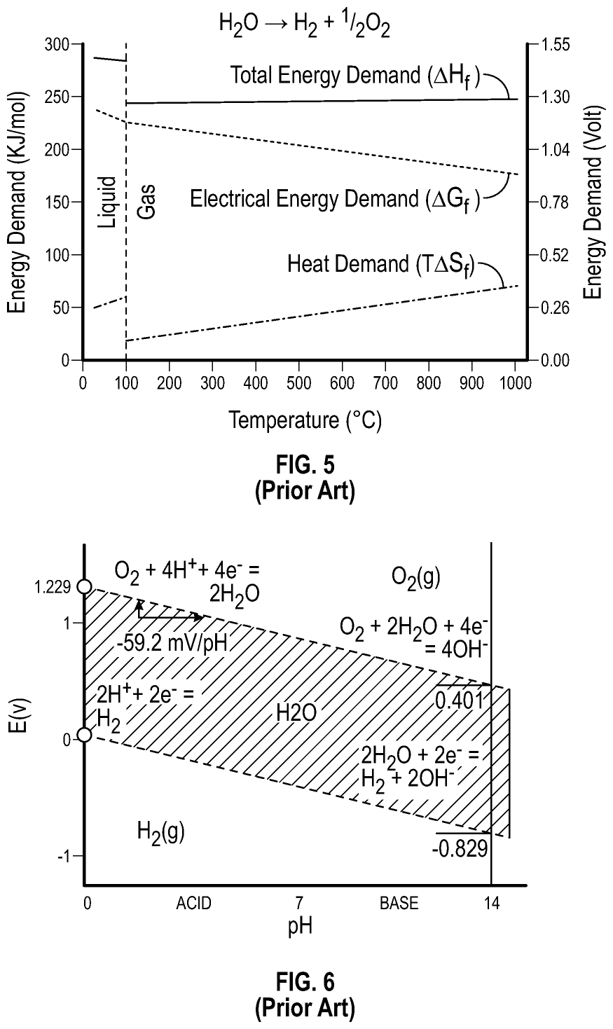

In addition to high temperature and high pressure, the discharged waste water from the steam boiler unit has a relatively high pH, such as up to 11. In one or more embodiments, the pH of the discharged waste water ranges from 2, 3, 4, 5, 6, 7, 8, 9, and 10 to 3, 4, 5, 6, 7, 8, 9, 10, and 11, where any lower limit may be combined with any mathematically feasible upper limit. The high pH may benefit the thermodynamics of water splitting, as illustrated in FIG. 6. FIG. 6 shows the Pourbaix diagram of water, where the Nernst potentials of anode and cathode are plotted against pH values. The individual potentials of the anode and cathode drop linearly with pH, whereas the thermodynamic stability window of water is unaltered at 1.229 V. When the cathode electrolyte remains unchanged, the required input voltage will be lowered by applying the alkaline boiler blowdown waste water to the oxygen electrode (i.e., anode).

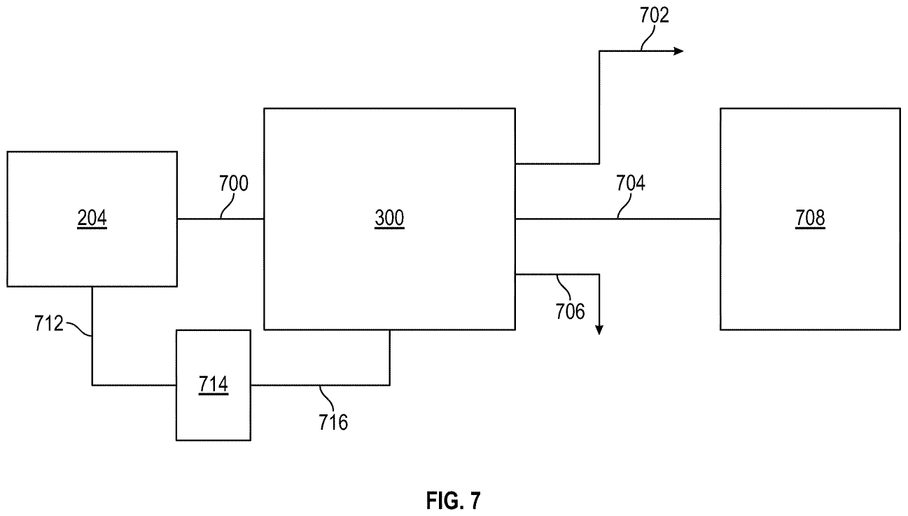

FIG. 7 is a diagram of a system for green hydrogen production according to one or more embodiments of the present disclosure. As shown, discharged waste water from the steam boiler unit 204 may flow through flow line 700 to the electrolysis unit 300. In the electrolysis unit 300, the discharged waste water may be decomposed into oxygen and hydrogen in an electrolysis reaction. The electrolysis of the discharged waste water in the electrolysis unit 300 may produce an oxygen stream in flow line 702 and a hydrogen stream in flow lines 704 and 706. The oxygen stream in flow line 702 may be released back into the air, or captured and stored for industrial processes, such as combustion, semiconductor production, and wastewater treatment.

The hydrogen stream in flow line 704 may be fed to a hydrogen storage unit 708, such as a storage tank. Hydrogen may be stored as a gas or a liquid. Hydrogen gas may be captured and stored in high-pressure tanks (e.g., 350-700 bar). Hydrogen in liquid form is stored at cryogenic temperatures. Hydrogen may also be stored on the surfaces of solids or within solids. The stored hydrogen may then be used at a later time for commercial or industrial purposes. Alternatively, the produced hydrogen may be output to a refinery. For example, the hydrogen stream in flow line 706 may be fed to a refinery to be used for operations, such as hydrodesulphurization, hydroisomerization, dearomatization, and hydrocracking. As would be appreciated by one skilled in the art, stored hydrogen may also be fed to a refinery.

In one or more embodiments, discharged waste water from the steam boiler unit 204 may flow through flow line 712 to one or more heat exchangers 714 before entering the electrolysis unit 300 via flow line 716. The temperature of the discharged waste water exiting the steam boiler unit 204 may be approximately 400° C. The one or more heat exchangers 714 may be utilized to reduce the temperature of the waste water to less than 120° C., which favors the thermodynamics and kinetics of proton exchange membrane water electrolyzer (PEMWE) systems while posing minimal damage to the PEM. In one or more embodiments, the reduced temperature of the waste water leaving the one or more heat exchangers 714 ranges from 50° C., 100° C., 150° C., 200° C., 250° C., 300° C., and 350° C. to 100° C., 150° C., 200° C., 250° C., 300° C., 350° C., and 400° C., where any lower limit may be combined with any mathematically feasible upper limit.

In summary, the systems and methods according to embodiments of the present disclosure utilize available high-pressure, high-temperature, and low-salinity upstream waste water sources (e.g., boiler blowdown) to enable energy-efficient green hydrogen production through electrolysis technology. The described approach is economically more efficient than conventional electrolysis processes for multiple reasons. First, a portion of the energy requirement for water splitting may be supplied as heat from the high-temperature upstream waste water stream. Second, the efficiency of the water splitting reaction may be greater at high-temperature conditions. Third, the hydrogen storage compression cost may be lower since the initial feed is already pressurized. Fourth, the energy cost for water desalination may be avoided as the upstream boiler blowdown stream has a relatively low TDS concentration. Therefore, the systems and methods described herein reduce the overall energy requirement of conventional electrolysis to enable cost-effective green hydrogen production.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for producing hydrogen, comprising:
a steam boiler unit configured to produce a discharged waste water stream;
an electrolysis unit configured to produce hydrogen and oxygen from the discharged waste water stream; and
a hydrogen storage unit for storing at least a portion of the hydrogen produced by the electrolysis unit as a product.

2. The system of claim 1, wherein the discharged waste water stream is produced via a boiler blowdown procedure.

3. The system of claim 1, further comprising a flow line for feeding at least a portion of the hydrogen produced by the electrolysis unit to a refinery.

4. The system of claim 3, wherein the hydrogen fed to the refinery is used for at least one of hydrodesulphurization, hydroisomerization, dearomatization, and hydrocracking.

5. The system of claim 1, further comprising:
one or more heat exchangers configured to receive the discharged waste water stream; and
at least one flow line connecting the steam boiler unit with the one or more heat exchangers,
wherein the one or more heat exchangers are further configured to reduce a temperature of the discharged waste water stream.

6. The system of claim 5, wherein the temperature of the discharged waste water stream is reduced to between approximately 50° C. and approximately 120° C.

7. The system of claim 1, wherein a temperature of the discharged waste water stream is between approximately 50° C. and approximately 400° C.

8. The system of claim 1, wherein the electrolysis unit is one of a proton exchange membrane (PEM) electrolyzer, an alkaline electrolyzer, or a solid oxide electrolyzer.

9. The system of claim 1, wherein a pH of the discharged waste water stream is between 2 and 11.

10. The system of claim 1, wherein a total dissolved solids (TDS) concentration of the discharged waste water stream is between approximately 100 milligrams (mg) per liter (L) and approximately 500 mg/L.

11. The system of claim 1, further comprising a flow line for releasing the oxygen produced from the discharged waste water stream.

12. A method for producing hydrogen, comprising:
producing, by a steam boiler unit, a discharged waste water stream;
feeding the discharged waste water stream to an electrolysis unit;
producing hydrogen and oxygen from the discharged waste water stream using the electrolysis unit; and
storing at least a portion of the hydrogen produced by the electrolysis unit in a hydrogen storage unit as a product.

13. The method of claim 12, wherein the discharged waste water stream is produced by performing a boiler blowdown procedure on the steam boiler unit.

14. The method of claim 12, further comprising outputting at least a portion of the hydrogen produced by the electrolysis unit to a refinery.

15. The method of claim 14, wherein the hydrogen fed to the refinery is used for at least one of hydrodesulphurization, hydroisomerization, dearomatization, and hydrocracking.

16. The method of claim 12, wherein a temperature of the discharged waste water stream is between approximately 50° C. and approximately 400° C.

17. The method of claim 12, further comprising:
feeding the discharged waste water stream from the steam boiler unit to one or more heat exchangers configured to reduce the temperature of the discharged waste water stream; and
feeding the discharged waste water stream having a reduced temperature to the electrolysis unit.

18. The method of claim 17, wherein the temperature of the discharged waste water stream is reduced to between approximately 50° C. and approximately 120° C.

19. The method of claim 12, wherein the oxygen produced from the discharged waste water stream is released.

20. The method of claim 12, wherein the oxygen produced from the discharged waste water stream is captured for use in industrial processes.
